(19) United States
(12) Patent Application Publication
(10) Pub. No.: US 2021/0026527 A1
(43) Pub. Date: Jan. 28, 2021

(54) METHOD FOR INTERACTION BETWEEN AT LEAST ONE USER AND/OR A FIRST ELECTRONIC DEVICE AND A SECOND ELECTRONIC DEVICE

(71) Applicants: Fabian HUMBERT, Saint-Maurice-de-Satonnay (FR); Guillaume MERROUCHE, Julienas (FR)

(72) Inventors: Fabian HUMBERT, Saint-Maurice-de-Satonnay (FR); Guillaume MERROUCHE, Julienas (FR)

(21) Appl. No.: 16/979,905

(22) PCT Filed: Mar. 18, 2019
(86) PCT No.: PCT/EP2019/056679

§ 371 Date: Sep. 11, 2020

(30) Foreign Application Priority Data
Mar. 19, 2018 (FR) 1852332

(51) Int. Cl. G06F 3/0488; G06F 21/31; G06F 9/54; H04L 29/08; G06T 1/20

(52) U.S. Cl. CPC G06F 3/04883; G06F 21/31; G06T 1/20; H04L 67/10; G06F 9/54

(57) ABSTRACT

A method for interaction between at least one user and/or at least one first electronic device including at least one processor, microprocessor, or a graphics processing unit called a GPU, a memory, an input/output port allowing the transmission of data to and from the electronic device and a display screen, and a second electronic device including at least one processor, microprocessor, or a graphics processing unit called a GPU, a memory, an input/output port allowing the transmission of data to and from the second electronic device and a tactile display screen. The method includes at least the following steps of: connecting at least one user and/or a first electronic device to the second electronic device, and generating a first graphical user interface, called a main GUI, on the tactile screen of the second electronic device for each user and/or each first electronic device connected to the second electronic device.

### TECHNICAL FIELD

The present invention concerns a method for interaction between, on the one hand, at least one user and/or at least one first electronic device and, on the other hand, a second electronic device comprising a touchscreen allowing, easily and intuitively, entering and/or modifying data simultaneously by several persons, on the same peripheral and/or on a plurality of peripherals.

### STATE OF THE ART

In the computer and telecommunications field, there are known computers with touchscreens such as mobile phones, called Smartphones, touch tablets or tables, laptops which can be used on a daily basis in increasingly growing uses, and in particular to identify and share information with other users.

This information sharing has become essential in everyday life whether in the private sphere and/or in the professional world.

Nonetheless, although they offer some interesting functions, the known sharing systems do not allow manipulating with others, simultaneously and in real-time, several objects and displaying them in real-time on different remote electronic devices. Indeed, the data sharing systems of the prior art enable the users only to act one at a time.

In order to overcome these drawbacks, there has already been imagined application and/or data sharing methods allowing improving interactivity during the data sharing. It is the case in particular of the American patent U.S. Pat. No. 8,965,349 and of the European patent application EP 2 869 188.

The document U.S. Pat. No. 8,965,349 describes a method for sharing an application in an interactive manner comprising a step of initiating, by a first electronic device, a communication with a second electronic device; after the beginning of the communication, of the transmission of a request of the first electronic device to participate to the sharing of an application with a second electronic device; of reception, at the level of the first electronic device, of the confirmation of sharing from the second display device; of display, on the first electronic device, of the application and of the data relating to the communication; of generation, at the level of the first electronic device, of an instruction to the second electronic device, said instruction relating to the display of the application on the second electronic device; and of the transmission of the instruction to the second electronic device. Said instruction consists of a screen image to be displayed on the second electronic device. Optionally, the communication may consist of a videoconference and, in this case, the data associated to the communication consist of images of the videoconference. Thus, several apparatus can share applications or application data such that each of the users of the electronic apparatuses could see the data of the application of another one or interact with the other one through a shared application.

In turn, the document EP 2 869 188 describes an electronic device for sharing an application and a method for monitoring said electronic device. The server electronic device communicating with a client electronic device comprises a communication unit configured to form a connection with the client electronic device, a controller configured to determine an application intended to be shared with the client electronic device, to generate shared data for the shared application, and to monitor the communication unit in order to transmit the shared data to the client electronic device, and a screen configured to display an execution screen of the shared application. The control method comprises a step of establishing a connection with the client electronic device, a step of determining an application to be shared with the client electronic device, a step of generating data of the shared application, said information being intended to be shared, and a step of transmitting the shared data to the client electronic device, said shared data then being displayed on the screen of said client electronic device.

These methods are implemented on electronic devices using a Microsoft®, Android® or IOS® type graphical user interface which is badly suited to an intuitive and effective interaction for the users.

There are also known the documents U.S. Pat. No. 7,327,376 and US 2004/0066414 which describe graphical user interfaces, commonly called GUI.

The document U.S. Pat. No. 7,327,376 describes a multi-user collaborative graphical user interface, called GUI. Said multi-user collaborative graphical user interface has a display area with a horizontal orientation, the display surface being positioned between the multiple users. The display area also has a centroid and a circumference. The display area is split into work areas so that there is a work area for each user of the multiple users positioned around a touch table. An element is displayed in a particular work area using a global polar coordinates system centered on said centroid.

This type of GUI has the drawback of limiting the work area of each user, said work area being even smaller as there is a large number of users around the table.

The document US 2004/0066414 describes a system and a method for managing software application windows in a graphical user interface having a desktop display area and a taskbar. Each instantiated program is represented as one or several graphical window(s) in the desktop and as a monitoring mosaic in the taskbar. The monitoring tiles are grouped together into groups of monitoring tiles which facilitate the organization and the unique access monitoring. The groups of project monitoring tiles enable the grouping of several software applications. In addition, the arrangement and the state of the minimized group of monitoring tiles may be preserved and pre-visualized before being restored. An indication is obtained to organize a graphical monitor relating to a software application and another monitor relating to another application. The graphical monitors are grouped together on a portion of the display. The commands are displayed as a group in the portion to instantiate an action on the commands by selecting a group constituted by minimized graphical windows.

This type of GUI is not suited for an interactive sharing of all types of documents, files, objects, applications, software or application or software data with an intuitive and effective interaction for the different users in real-time around the same touch table or several touch table remotely connected.

There is also known the document US 2010/0095233 which describes a method, a device and a system for extracting and displaying technical data for an industrial device supervised by a computer program for a monitoring, a configuration or a condition supervision in industrial or commercial facilities. In particular, it describes the use of a substantially static and large-sized active display element, such as a touch table, to provide a graphical user interface in order to manipulate data for one or several industrial device(s) and/or to control them. Said touch table includes «reception areas» displaying programs or applications preselected by the user, said user is identified by an object provided with an RFID tag. A computer device or a mobile computer device, such as a PDA, can send a link or a reference of an application, an interface or a document to the large-sized active screen so that different applications interfaces could be displayed by the large-sized active screen in order to facilitate the extraction, the manipulation of information as well as access to information.

This type of devices has the drawback of including a predetermined, and therefore limited, number of «reception areas», i.e. GUIs.

Hence, there is a need for an effective, simple, intuitive, stable solution enabling the interactive sharing of all types of documents, files, objects, applications, software or application or software data with an intuitive and effective interaction for the different users in real-time and a display feedback in real-time on all of the apparatuses desired by the users, whether these are remote or not.

### DISCLOSURE OF THE INVENTION

Hence, an object of the invention is to overcome these drawbacks by providing a method for interaction with a graphical user interface, called GUI, and for interactive sharing of applications and data between computers with a touchscreen and a computer program for the implementation of said method with a simple and inexpensive design and enabling the interactive sharing of all types of documents, files, objects, applications, software or application or software data with a multi-user interaction in real-time and a display feedback in real-time on all of the desired apparatuses with an intuitive and effective interaction with the graphical interface.

To this end and in accordance with the invention, there is provided a method for interaction between, on the one hand, at least one user and/or at least one first electronic device, said first electronic device comprising at least one processor or microprocessor or a graphics processor, called GPU standing for «Graphics Processing Unit», a memory, an input/output port enabling data transmission towards and from said electronic device and a display screen and, on the other hand, a second electronic device comprising at least one processor or microprocessor or a graphics processor, called GPU standing for «Graphics Processing Unit», a memory, an input/output port enabling data transmission towards and from said second electronic device and a touchscreen; said method is remarkable in that it includes at least the following steps:
connection of at least one user and/or a first electronic device to the second electronic device,
generation of a first graphical user interface, called main GUI, on the touchscreen of the second electronic device for each user and/or each first electronic device connected to said second electronic device.

Moreover, the method according to the invention includes a step of importing into the main GUI of said user and/or of said first electronic device data and/or files and/or applications or software, or applications and software data from each user and/or from each first electronic device connected to a sharing module, said sharing module consisting of a computer program enabling the interactive sharing of data, files, applications or software, or of applications and software data on the second electronic device.

Said sharing module is recorded in a server and/or in the memory of the second electronic device and/or in the memory of the first electronic device.

Preferably, said method includes a step of generating at least one second graphical user interface, called secondary GUI, related to the main GUI and in which at least one command and/or at least one datum of at least one application are displayed.

Said user connection step is carried out according to at least the following steps:
pressing for a determined duration, lasting at least 1 second, with at least one finger and/or at least the palm of the hand of a user on the touchscreen of the second electronic device,
generation of a window including a user identification system on the screen,
transmission of the login information to the sharing module,
opening of a sharing session in the sharing module after check-up of the login information of the user.

Said identification system consists of a QR code and/or a facial recognition system and/or a voice recognition system and/or a biometric recognition system and/or an identifier field and a password field.

According to one variant, the user connection step is carried out according to at least the following steps:
detection of a first electronic device of a user through a wireless network or a wired network connected to the second electronic device,
transmission of the login data stored in the first electronic device from the user to the sharing module,
opening of a sharing session in the sharing module after check-up of the login data: the identifier and the password of the user.

Said login data consist of at least one identifier and one password.

Moreover, the main GUI and/or the secondary GUI(s) have a circular shape.

In addition, the secondary GUI(s) are positioned in the proximity of the main GUI.

Preferably, the method according to the invention includes a step of displaying in the main GUI the profile picture of the user connected to the second electronic device or, failing that, an avatar.

Said profile picture is imported from the sharing session opened by the user and/or the first electronic device in the sharing module.

Moreover, the method according to the invention comprises a step of generating at least one alphanumeric pad displayed in a window associated to at least one first graphical user interface and/or to at least one second graphical user interface and/or to at least one window.

A click on a button of said alphanumeric pad generates a code, called scan code, which is associated to a character and/or an action in the first graphical user interface and/or the second graphical user interface and/or allows writing in the window.

In addition, said method includes a step of generating at least one command from an interaction between at least one user and the second electronic device, such as for example a touch table.

Said interaction consists of a press and/or a displacement with at least one finger of at least one hand and/or of the side of at least one hand and/or of the palm of at least one hand on the touchscreen of the second electronic device which generates a query transmitted to at least one amongst the electronic devices.

Another object of the invention concerns a computer program product comprising a sequence of instructions for the implementation of an interaction method according to the invention.

### BRIEF DESCRIPTION OF THE DRAWINGS

Other advantages and features will better appear from the following description of several variants, provided as non-limiting examples, of the method for interaction with a graphical user interface of a touch table or tablet and for interactive sharing of applications and data between computers with touchscreen and of the computer program for the implementation of said method according to the invention, from the appended drawings in which:

FIG. 1 is a schematic perspective view of the connection of an electronic device with a touch tablet,

FIG. 2 is a graphical representation of the user interface according to the invention,

FIG. 3 is a graphical representation of the prior step of connection of the electronic device with a touch table,

FIG. 4 is a graphical representation of the user interface with alphanumeric pads according to the invention,

FIG. 5 is a schematic representation in the form of a diagram of a computer with a touchscreen in accordance with the invention,

FIG. 6 is a schematic representation in the form of a diagram of a first application of the method in accordance with the invention enabling at least two users to share data on one single computer with a touchscreen in accordance with the invention,

FIG. 7 is a schematic representation in the form of a diagram of a second application of the method in accordance with the invention enabling at least one user of a first computer with a touchscreen according to the invention to share data with at least one other user of at least one second touch computer in accordance with the invention,

FIG. 8 is a schematic flowchart of the first step of the method in accordance with the invention,

FIG. 9 is a schematic flowchart of the second step of the method in accordance with the invention,

FIG. 10 is a schematic flowchart of the third step of the method in accordance with the invention,

FIG. 11 is a schematic flowchart of the fourth step of the method in accordance with the invention,

FIG. 12 is a schematic flowchart of the fifth step of the method in accordance with the invention,

FIG. 13 is a schematic flowchart of the sixth step of the method in accordance with the invention,

FIG. 14 is a schematic flowchart of a seventh step of the method in accordance with the invention,

FIGS. 15 to 25 are schematic representations of metaphors causing commands at the graphical user interface.

### EMBODIMENT OF THE INVENTION

We will describe hereinafter a computer such as a tablet or table with a touchscreen including a user interface in accordance with the invention; nonetheless, it is obvious that the computer may consist of any type of computer, whether with a touchscreen or not, such as a smartphone or a PC-type computer, yet without departing from the scope of the invention.

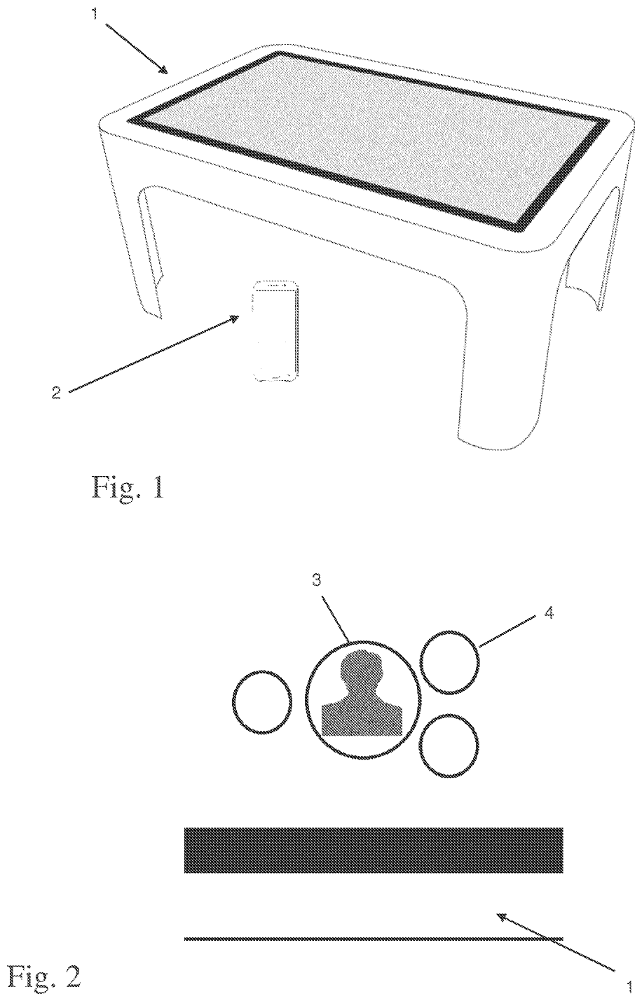

Referring to FIG. 5 which is a block diagram of an example of an electronic device 100 which may be used to share, in an interactive manner, the applications and/or the data and/or the peripherals in accordance with the invention, said electronic device 100 may be a mobile apparatus, such as a smartphone, a touch table or tablet, a laptop, a digital camera, a digital telephone handset or the same, said electronic device 100 comprises at least one processor 110, called CPU, standing for «Central Processing Unit», which controls the different operations of the electronic apparatus 100 and can interact with the other components of the device. Said processor 110 may consist of any processor known to those skilled in the art such as a Pentium® or Atom® processor commercialized by the company INTEL® or an A4 or A5 processor commercialized by the company Apple®, for example. The processor may consist of a simple-core microprocessor or of a multi-core microprocessor. By multi-core microprocessor, it should be understood a microprocessor having several physical cores which operate in parallel, each physical core consisting of a set of circuits capable of executing programs in a standalone manner and all of the functions that are necessary to the execution of a program being present in these cores: program counter, registers, computing units, etc. . . . . Moreover, it should be noted that the electronic device 100 may include several processors even though only one is represented in FIG. 1. For example, a so-called graphics processor, also called GPU, standing for «Graphics Processing Unit», may be used, said graphics processor consisting, in a manner well known per se, an integrated circuit generally present on a graphics board, a motherboard or the processor 110 (CPU) and ensuring the display computation functions.

It is obvious that the electronic device 100 could be a stationary device, such as a desktop computer, called PC, a digital phone base, a television set, a media center or the same, yet without departing from the scope of the invention.

Moreover, it should be observed that, in FIG. 5, the lines linking the different elements of the electronic device represent communication pathways between said elements, these communication pathways may be bidirectional or omnidirectional.

Besides the microprocessor 110, the electronic device 100 includes a memory 120, or any other similar storage device, a users' input module 130, an input/output port 140 to enable data transmission towards and from the electronic device 100, a display screen 150 and inner or outer peripherals 160. For example, said inner or outer peripherals 160 consist of a camera to enable a user of the electronic device according to the invention to proceed with a videoconference with another person, such as a user of a second electronic device, a camera, a printer, an infrared detector of sensors. It should be noted that the users' input module 130 generally enables a user to manipulate some functions of the electronic device 100, including interacting with and sharing applications installed on the storage of the apparatus and executed by the processor 110, and may consist of a peripheral such as a touchpad, a keyboard, a mouse, a stylus or the same, said peripheral may be connected to the electronic device either in a wired manner or by means of a wireless connection (Wi-Fi or Bluetooth for example), or a touchscreen, said touchscreen also forming the display screen 150. This touchscreen may consist of a capacitive-, resistive-type screen or based on the interference with electromagnetic wavelengths or of another type of so-called touchscreen well known to those skilled in the art.

Moreover, the electronic device according to the invention includes a software, called sharing module, 170 which allows monitoring the aspects and the interactions relating to the interactive sharing of one or several application(s) and/or data and/or peripherals as will be detailed later on. By software, it should be understood a set of instructions sequences which can be interpreted by a machine or a set of data necessary to these operations. Thus, the software includes a computer program which is stored in the memory 120 and executed by the processor 110 each time the applications are shared or the sharing is initiated.

It goes without saying that the sharing module 170 may consist of a microprogram, hardware or software or of a combination of these, yet without departing from the scope of the invention. Moreover, said sharing module 170 may be hosted, entirely or partially, on a server or another remote device accessible by the other electronic devices involved in the sharing of applications.

This sharing module 170 enables the interactive sharing of data, files, applications or software, or of applications and software data on one single electronic device 100 between several users or between two electronic devices or more, whether these are local or remote.

Hence, said data, files, applications, software, or application and software data may be accessible by multiple users on multiple apparatuses. Several users may even be on the same apparatus such as for example a touch table, or a vertical interactive screen. Moreover, some electronic devices may be without users, such as servers. Each user can then access to data, files, applications or software, or applications and software data that have been made accessible. Each user of each electronic device can display, visualize, modify and manipulate different files, data, objects, applications or software in real-time throughout a software or a shared application; that being alone or with others on each electronic device and perform all the operations simultaneously with the other users. Thus, the sharing module 170 enables all users to be able to simultaneously interact at the same time on all apparatuses alone or with others on each apparatus. Sharing will be possible depending on the possible rights granted to each user to display, visualize, modify and manipulate the different data, files, objects, applications or software or applications or software data; and even, depending on the possible rights granted to each datum, file, object, application or software or applications or software datum.

All of the actions of the users may be executed simultaneously with an almost immediate display feedback on the different electronic devices according to the invention.

In this manner, several users can share information and collaborate without necessarily having to be physically present, as they could wish to be around one single device and to simultaneously interact together on one single electronic apparatus.

For example, a user can manipulate a plane on an interactive touch table in Paris, said interactive touch table forming a first electronic device according to the invention, while another person takes notes on the corner of the table on this same table, while a third person draws in another corner on another touch table in New York, i.e. on a second electronic device according to the invention, while a fourth one displays at the middle what the camera of his smartphone, i.e. a third electronic device according to the invention, is filming in Moscow, while others visualize on an interactive table in Tokyo and can interact with each element. Thus, all users can see the different graphical elements and interact with them.

To this end, all of the electronic devices are capable of communicating with one another through any mode (network, telephone communication or other), all of the devices are equipped with electronic components and drivers enabling the dialog of the electronic devices with one another or at least with the electronic device referred to as a server.

An electronic device can act as a host of the software of the interactive sharing solution, the other electronic devices may then only have to transmit their data or the actions of the users via this same sharing application which is also installed on the electronic device. The «server» application can then send the display information to the different electronic devices that wish to have the display feedback. The orientation of the different displayed objects can be interpreted by the electronic device on which it is displayed to adapt the orientation to the use.

The interaction and sharing module 170 also serves as a gateway to manage and organize the interface of the users and of all of the electronic devices and functions of all of the apparatuses and of all of the peripherals of the inner or outer devices. The mode of interaction of the user with the electronic device depends on each electronic device itself. All user-electronic device interaction modes are possible.

During a remote use, the solution according to the invention allows limiting the load of the bandwidth by not continuously transmitting a video on the screen of a user, in contrast with the methods of the prior art. In accordance with the invention, each electronic device has its own screen with its own graphical widgets which interact together. By widget, it should be understood a software component. Moreover, the rendering quality on the screen is also improved for the elements that will not be compressed.

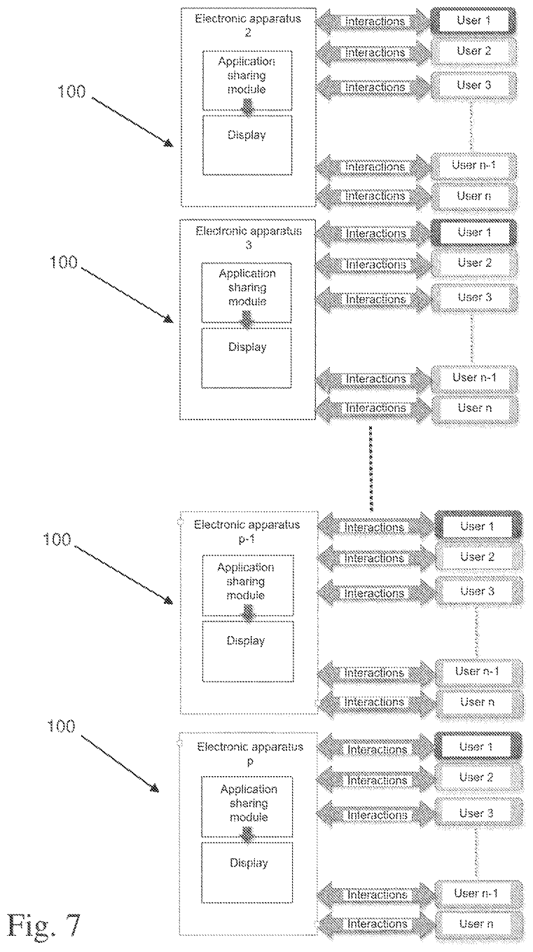

Referring to FIG. 7, at least two users or more (n users) interactively share data, files, applications or software, or applications and software data on an electronic device 100 and can simultaneously interact with the different elements. This solution enables an active collaboration of each user on the electronic device 100 simultaneously. The advantage of this solution is to enable n users to collaborate, interact together in real-time and simultaneously and to share all kinds of data, files, applications or software, or applications and software data.

Referring to FIG. 8, at least one user or more interactively shares data, files, applications or software, or applications and software data on a first electronic device 100 with at least one other user on at least one other electronic device and can simultaneously interact with the different users of the different electronic devices. This solution enables an active collaboration of each user on the different electronic devices simultaneously with a display feedback almost in real-time on the different devices enabling the display. In particular, this solution is interesting when there are at least two users who wish to share, collaborate and interact on at least two remote electronic devices, which enable them to collaborate, perform interactive sharing of data, files, applications or software, or applications and software data without having to be physically present in the same geographical location.

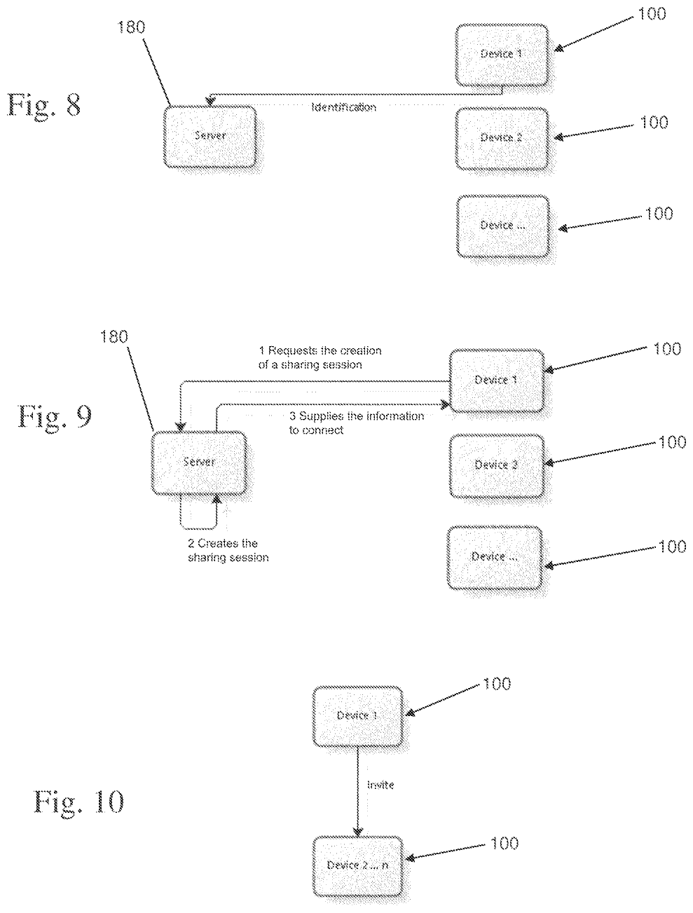

Referring to FIGS. 8 to 14, the sharing module 170 enables, in a first step (FIG. 8), a connection of a first electronic device 100 to a server 180 via an Internet connection, for example, and an identification of the first electronic device 100 by said server 180 as a client. Referring to FIG. 9, the first electronic device 100 then transmits to the server 180 a query for the creation of a sharing session, then the server 180 creates a sharing session and transmits the information relating to this sharing session to said first electronic device 100. Referring to FIG. 10, the first electronic device 100 sends an invitation to connect to the sharing session to other electronic devices 100. This invitation may be performed in different manners. According to a first embodiment, a user sends an e-mail from the first electronic device 100 to users of other electronic devices. According to a second embodiment, an e-mail for invitation to connect to the sharing session is automatically generated by the server 180 and sent by said server 180 to users of other electronic devices. Alternatively, the invitation to connect to the sharing session may be performed by phone, by a so-called In-App notification, etc. . . . , yet without departing from the scope of the invention. It should be noted that each new electronic device having received the invention to connect to the sharing session can also send an invitation to connect to said session to other devices, for example via the e-mail address book.

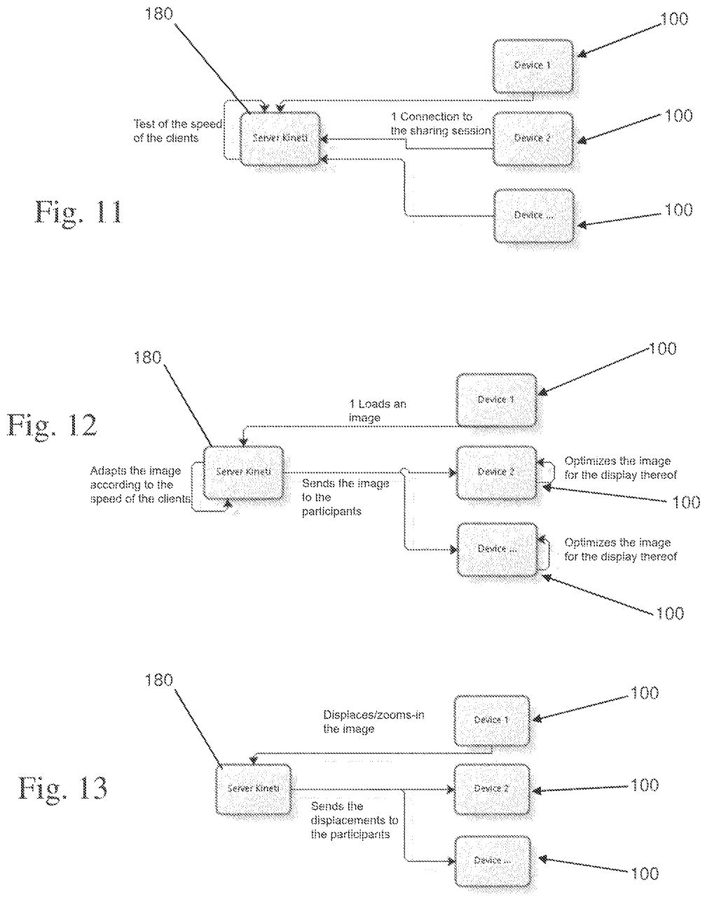

Referring to FIG. 11, the other electronic devices 100 accept the invitation of the server 180 which, afterwards, tests the speed of the connection of each electronic device 100 with the server 180. Each time an electronic device connects to the server, the speed of the connection is tested to select the information transmission mode and the information sending quality. In this manner, the chances of having regular and pleasant exchanges are maximized. Moreover, the speed of the connection is tested later on at regular intervals in order to adapt the transmission mode and the sending quality according to the bandwidth of the connection.

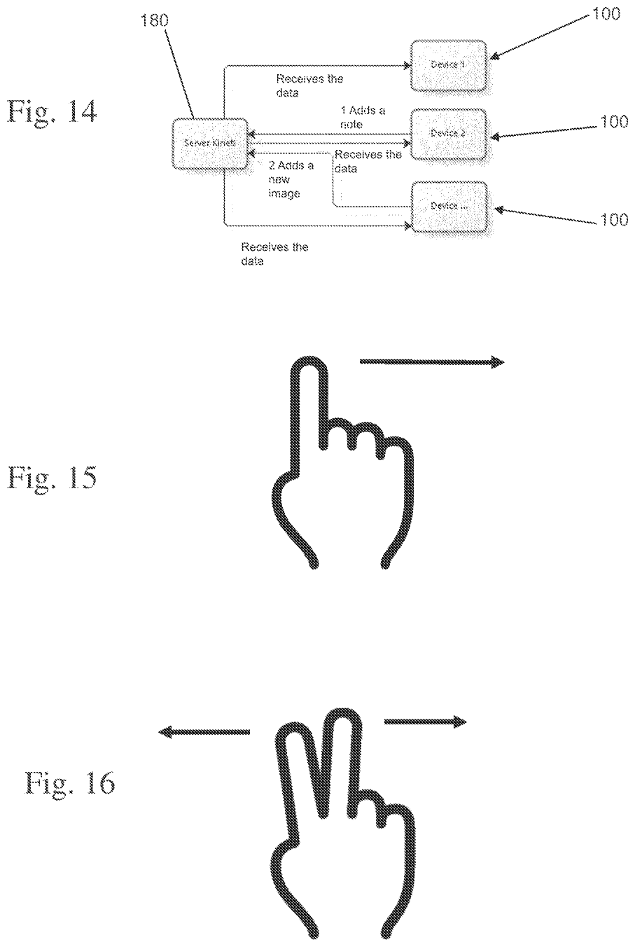

When the first electronic device 100 loads data, such as for example an image, referring to FIG. 12, said image is transmitted in real-time to the other electronic devices 100. It should be noted that, according to the speed of the connection between the electronic devices 100 and the server 180, said image transmitted by the server 180 to the other electronic devices may be compressed as will be detailed later on. The image is downloaded once by the users, by modifying, where necessary, the size of said image if the connection of the different users is not effective enough or if the image is too large. The image is possibly compressed to minimize the used speed. Thus, rendering on the display screens of the electronic devices is the same, without any loss of quality of the image and only the image is transmitted and not the entirety of the screen in contrast with the methods of the prior art. When the user of the first electronic device proceeds with an action on the image from his electronic device, such as a displacement of the image or a zooming-in for example, referring to FIG. 13, the data relating to the displacement and/or to the zooming-in are transmitted to the server 180 which forwards these data to the other electronic devices 100 such that the displacement and/or the zooming-in of the image is displayed on the screens of the other electronic devices 100. In this manner, the image is not downloaded again, only the change of position and the change of zooming factor is transmitted to the server 180 from the different electronic devices. Thus, the bandwidth is saved considerably in comparison with a streamer of the prior art. Next, referring to FIG. 14, when an electronic device 100 adds a note and when another electronic device 100 adds a new image, the data are transmitted respectively to the server 180 which transmits them afterwards in real-time to all of the other electronic devices for said data to be displayed on said electronic devices.

Moreover, referring to FIG. 1, in the context of a local use on a second electronic device in the form of a touch table 1, i.e. when one or several user(s) are around the touch table 1, whether sharing the same sharing session or not, the method according to the invention for interaction between, on the one hand, at least one user and/or at least one first electronic device 2, said first electronic device 2 comprising at least one processor or microprocessor or a graphics processor, called GPU standing for «Graphics Processing Unit», a memory, an input/output port enabling data transmission towards and from said electronic device and a display screen and, on the other hand, a second electronic device 1 comprising at least one processor or microprocessor or a graphics processor, called GPU standing for «Graphics Processing Unit», a memory, a users' input module, an input/output port enabling data transmission towards and from said second electronic device 1 and a touchscreen; includes at least the following steps:
connection of at least one user and/or a first electronic device 2 to the second electronic device 1,
generation of a first graphical user interface, called main GUI, 3 on the touchscreen of the second electronic device 1 for each user and/or each first electronic device 1 connected to said second electronic device 2.

Moreover, the method includes a step of importing into the main GUI of said user and/or of said first electronic device data and/or files and/or applications or software, or applications and software data from each user and/or from each first electronic device connected to a sharing module, said sharing module consisting of a computer program enabling the interactive sharing of data, files, applications or software, or of applications and software data on the second electronic device.

It should be observed that said sharing module is indifferently recorded in a server and/or in the memory of the second electronic device 1 and/or in the memory of the first electronic device 1.

Preferably, referring to FIG. 2, the method includes a step of generating at least one second graphical user interface, called secondary GUI, 4 related to the main GUI 3 and in which at least one command and/or at least one datum of at least one application are displayed. In this particular embodiment, the main GUI 3 and/or the secondary GUI(s) 4 have a circular shape and the secondary GUI(s) are positioned in the proximity, such as at the periphery, of the main GUI. Nonetheless, it is obvious that the main GUI 3 and/or the secondary GUI 4 may have any shape, yet without departing from the scope of the invention. Moreover, advantageously, the method includes a step of displaying in the main GUI 3 the profile picture of the user connected to the second electronic device 1 or, failing that, an avatar, said profile picture being, for example, imported from the sharing session opened by the user and/or the first electronic device 2 in the sharing module.

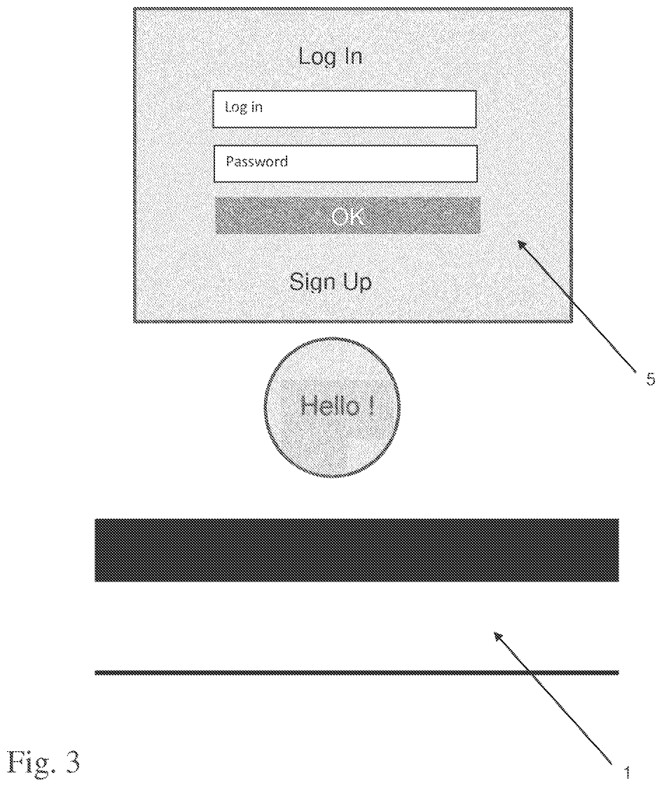

Referring to FIG. 3, the user connection step is carried out according to at least the following steps:
pressing for a determined duration, lasting at least 1 second, with at least one finger and/or at least the palm of the hand of a user on the touchscreen of the second electronic device 1,
generation of a window 5 including a user identification system on the screen,
transmission of the login information to the sharing module,
opening of a sharing session in the sharing module after check-up of the login information of the user.

In the embodiment represented in FIG. 3, the identification system consists of an identifier field and of a password field; nonetheless, it goes without saying that the identification system could consist of another type of identification system such as a QR code and/or a facial recognition system and/or a voice recognition system and/or a biometric recognition system, etc., yet without departing from the scope of the invention.

According to a variant of the method according to the invention, the user connection step is carried out according to at least the following steps:
detection of a first electronic device 2 of a user through a wireless network or a wired network connected to the second electronic device 1,
transmission of the login data stored in the first electronic device 2 from the user to the sharing module,
opening of a sharing session in the sharing module after check-up of the login data: the identifier and the password of the user.

For example, said login data consist of at least one identifier and one password which are advantageously recorded in the memory of the first electronic device 2.

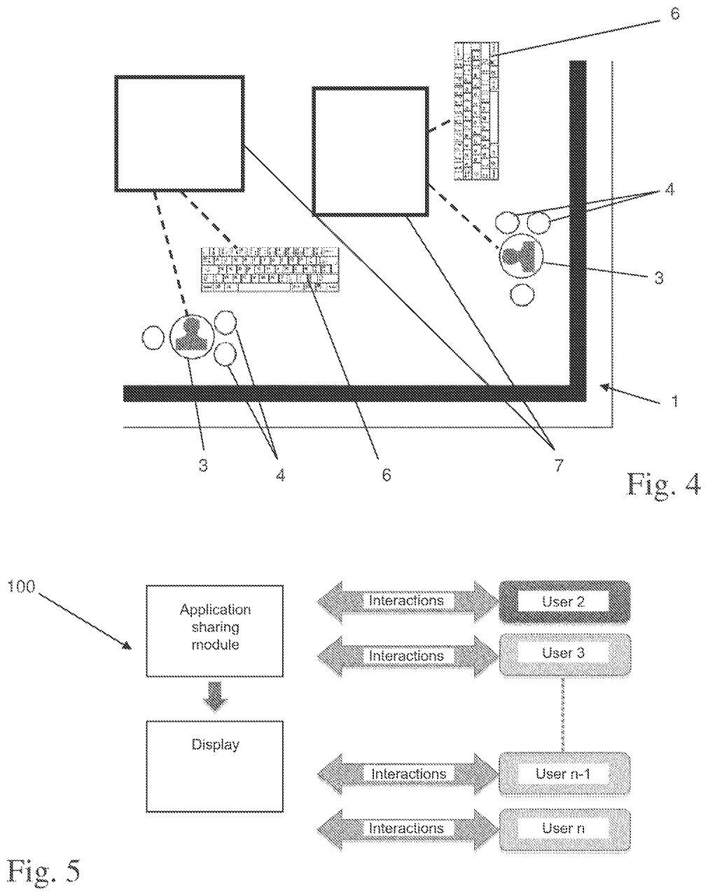

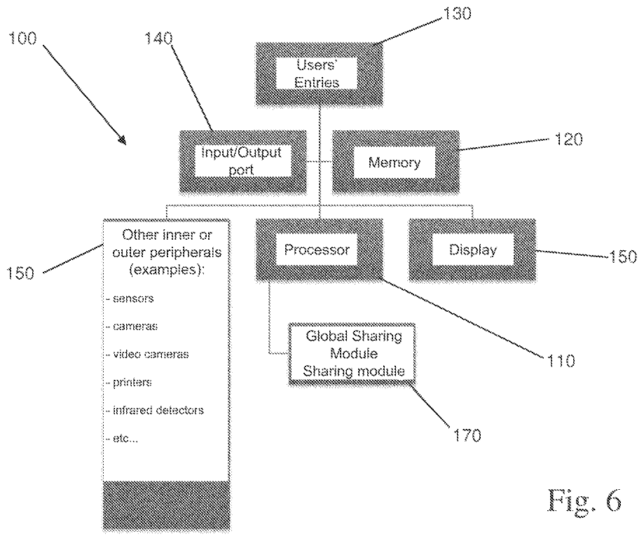

Advantageously, referring to FIG. 4, the method comprises a step of generating at least one alphanumeric pad 6 displayed in a window associated to at least one first graphical user interface and/or to at least one second graphical user interface and/or to at least one window 7, the first and/or the second user interface consisting of a main GUI 3 or of a secondary GUI 4. By the term «associated», it should be understood the fact that the alphanumeric pad 7 interacts with the first graphical user interface and/or the second graphical user interface and/or a window 7. Thus, the alphanumeric pad 7 allows entering a command query for the first graphical user interface and/or the second graphical user interface and/or allows writing in the window 7 in particular. More specifically, a click on a button of said alphanumeric pad 7 generates a code, called scan code, which is associated to a character and/or an action in the first graphical user interface and/or the second graphical user interface and/or allows writing in the window 7.

In addition, the method also includes the generation of at least one command from an interaction between at least one user and said electronic device in the form of a metaphor. Said interaction is carried out by a press, whether very short and/or short and/or long, and/or a displacement with at least one finger of at least one hand and/or of the side of at least one hand and/or of the palm of at least one hand on the touchscreen of the device generates a query transmitted to at least one amongst the electronic devices.

Referring to FIG. 15, a first metaphor consists of a long touch, i.e. a touch held for several seconds, on a window with a finger of a hand and of a linear or curvilinear displacement, this metaphor generating a displacement of the window.

Referring to FIG. 16, a second metaphor consists of a long touch with two fingers in a window and a displacement of the two fingers, either in the form of a spacing of the fingers or in the form of an approach of said fingers, to cause a zooming-in or respectively zooming-out of the content of the window.

Referring to FIG. 17, a third metaphor consists of a long touch with two fingers in a window and a simultaneous rotation of said fingers to cause a rotation of the window in the direction of rotation of the fingers.

Referring to FIG. 18, a fourth metaphor consists of a long touch with three fingers in a window and an upward displacement to cause a withdrawal of the window in a taskbar of the user interface.

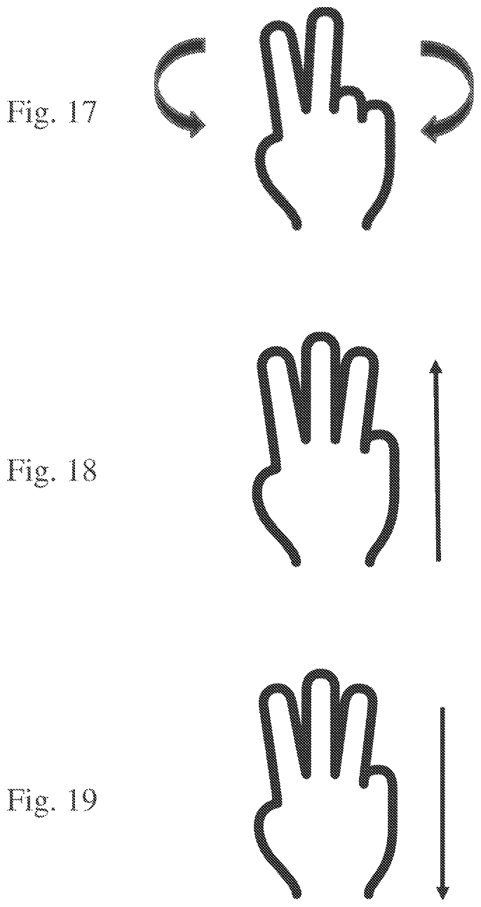

Referring to FIG. 19, a fifth metaphor consists of a long touch with three fingers in a window and a downward displacement to cause a withdrawal of the window below the main box 3.

Referring to FIG. 20, a sixth metaphor consists of a short touch with three fingers in a window displaying an Internet browser and a rightward or leftward displacement to cause a scrolling of the next, or respectively previous, Internet page.

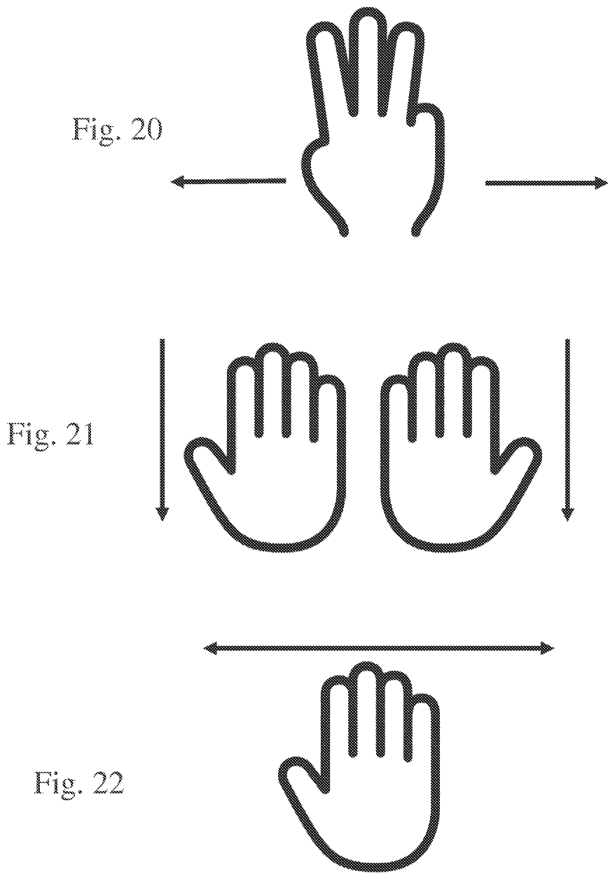

Referring to FIG. 21, a seventh metaphor consists of a short touch with the ten fingers of both hands of the user and a downward displacement to cause a reduction of all open windows in the taskbar of the user interface or below the main box 3 of the user.

Referring to FIG. 22, an eight metaphor consists of a long touch with the palm of the hand and a circular displacement to cause a wipe-out (closure) of all open windows.

Referring to FIG. 23, a ninth metaphor consists of a long touch with the side of the hand in a window and a rectilinear displacement to cause a cut of the content of the window.

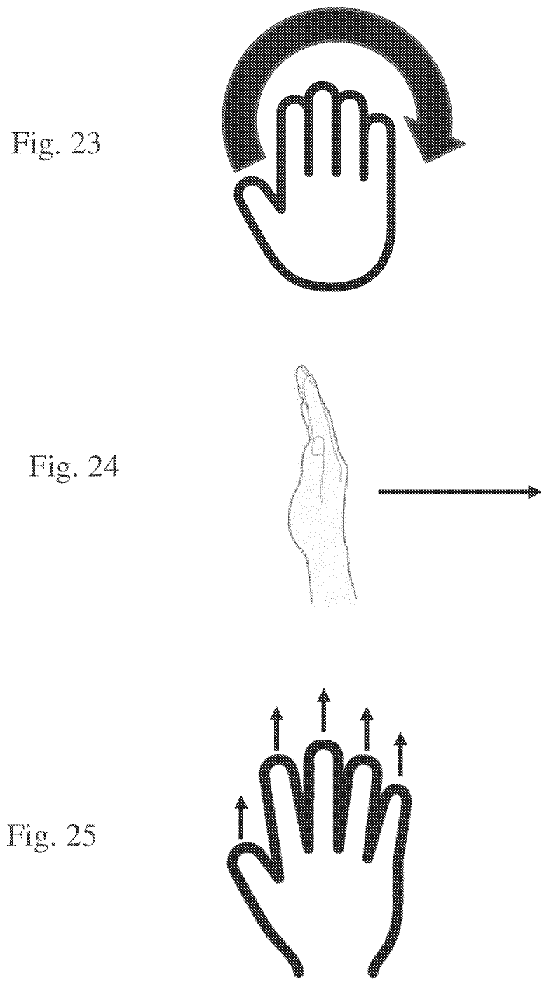

Referring to FIG. 24, a tenth metaphor consists of a quick tapping with several fingers of a hand on the touchscreen to cause the display of a new window containing an alphanumeric pad, the latter being associated with the active window for example so as to allow writing in said window in particular.

In general, all of the interactions by means of metaphors may be summarized in the table hereinbelow.

| Metaphors | Commands |
|---|---|
| Continuous or discontinuous touch on | Displacement of the window according |
| a window with a finger of a hand and a | to a trajectory parallel to the |
| linear or curvilinear displacement | displacement of the finger |
| Continuous or discontinuous touch on | Displacement of the window according |
| a menu bar of a window with at least | to a trajectory parallel to the |
| one finger of a hand and a linear or | displacement of the finger |
| curvilinear displacement | |
| Continuous or discontinuous touch with | Displacement of the window according |
| two or three fingers in a window and a | to a trajectory parallel to the barycenter |
| linear or curvilinear displacement | of the coordinates of one or several |
| | finger(s) |
| Continuous or discontinuous touch with | Zooming-in, or respectively zooming- |
| 2/3/4/5 fingers in a window and a | out, of the content of the window |
| displacement of the fingers, either in | |
| the form of a spacing of the fingers or | |
| in the form of an approach of said | |
| fingers | |
| Continuous or discontinuous touch with | Rotation of the window in the direction |
| 2/3/4/5 fingers in a window and a | of rotation of the fingers |
| simultaneous rotation of said fingers | |
| Double touch with 2/3/4/5 fingers | Select a paragraph of a text and/or the |
| | entire text and/or a window and/or the |
| | object on which the metaphor is carried |
| | out, entirely or partially |
| Continuous or discontinuous fingers | Slipping the content of the window |
| with 2/3/4/5 fingers in a window and a | upwards and, respectively, downwards |
| linear displacement of the fingers in | |
| parallel upwards or downwards | |
| Touch with 2/3/4/5 fingers in a window | Withdrawal of the window in a taskbar |
| and au upward displacement | of the user interface or output of the |
| | window upwards of the screen |
| Touch with 2/3/4/5 fingers in a window | Withdrawal of the window below the |
| and a downward displacement | main box and/or withdrawal of all of the |
| | windows below the main box |
| | and/or withdrawal of one or several |
| | window(s) with a disappearance |
| | downwards and/or closures of one or several |
| | window(s) |
| Touch with 2/3/4/5 fingers in a window | Scrolling towards the next Internet |
| displaying an Internet browser and a | page or, respectively, return to the |
| rightward or leftward displacement | previous window |
| | and/or |
| | Cancel the previous query/function |
| | and/or repeat the previous |
| | query/function |
| Brief or long touch with the ten fingers | Reduction of all open windows in the |
| of both hands of the user and a | taskbar of the user interface or below |
| downward displacement | the user interface |
| | and/or closure of all windows |
| Brief or long touch with the ten fingers | Locking of the screen |
| of both hands of the user | and/or |
| | Closure of one or several open |
| | window(s) |
| | and/or |
| | Copy and/or Cut and/or Paste the |
| | content or a portion of the content of |
| | the window |
| Touch with the palm of the hand and a | Locking of the screen |
| circular displacement | and/or |
| | Wipe-out (closure) of all open windows |
| Long touch with the side of the hand in | Copy and/or Cut and/or Paste the |
| a window and a rectilinear | content or a portion of the content of |
| displacement | the window |
| Quick tapping with several fingers of | Display of a new window containing an |
| one or several hand(s) on the | alphanumeric pad |
| touchscreen | |
| Continuous and/or discontinuous touch | Duplicate the window and/or the |
| with one or several finger(s) of each | content of the window |
| hand on a window and then slipping of | |
| each hand in an opposite direction | |
| Put the 5 fingers of one hand on a | Disappearance/reduction/zoom-out of |
| window and approach of the fingers | the window |
| Put the 5 fingers of one hand on a | Apparition/extension/zoom-in of the |
| window and spacing of the fingers | window |
| Put the hand and/or the side of the | Put aside the elements and/or |
| hand with a windshield wiper like | reorganize the displayed elements |
| movement | and/or wipe out one or several |
| | window(s) and/or lock the screen |
| Put the hand and/or a portion of the | Put aside the elements and/or |
| hand and/or a fist and/or one or | reorganize the displayed elements |
| several finger(s) with a circular | and/or wipe out one or several |
| movement | window(s) and/or lock the screen |
| Put a hand and/or a portion of the hand | Select a paragraph of a text and/or the |
| and/or a fist and/or one or several | entire text |
| finger(s) of a hand which remains static | or |
| over the touch surface and | Delete the entire word located to the |
| simultaneously draw a shape and/or a | left of the cursor |
| letter and/or a digit and/or a special | or |
| character and/or a symbol with one or | Copy a text, an image, a selected file |
| several finger(s) in the proximity of the | or |
| static hand | Delete a document, an icon, a window, |
| | etc. |
| | or |
| | Delete one or several entire word(s) |
| | located to the right of the cursor and/or |
| | located before the cursor and/or |
| | selected |
| | or |
| | Displace the cursor by skipping one |
| | word each time |
| | or |
| | Open the file open window |
| | or |
| | Open the print window |
| | or |
| | Print the selected element(s) (text |
| | and/or icons and/or images and/or an |
| | object) |
| | or |
| | Save a document and/or a text and/or |
| | an image |
| | or |
| | Paste a text and/or an image and/or a |
| | selected file and/or an element and/or |
| | a selected window |
| | or |
| | Close a window |
| | or |
| | Cut a text and/or an image and/or a |
| | selected file and/or a selected window |
| | or |
| | Delete the last written text |
| | or |
| | Cancel the effect of a Ctrl + Z |
| | or |
| | Highlight the first menu of the window |
| | currently displayed and/or selected |
| | and/or on which the metaphor is |
| | performed |
| | or |
| | Highlight the first menu of the window |
| | currently displayed and/or selected |
| | and/or on which the metaphor is |
| | performed |
| | or |
| Put a hand and/or a portion of the hand | Allows highlighting the menu of the |
| and/or a fist and/or one or several | window currently displayed and/or |
| finger(s) of a hand which remains static | selected and/or on which the metaphor |
| over the touch surface and | is performed whose letter is underlined |
| simultaneously draw a shape and/or a | or |
| letter and/or a digit and/or a special | Close the window currently displayed |
| character and/or a symbol with one or | and/or selected and/or on which the |
| several finger(s) in the proximity of the | metaphor is performed |
| static hand | or |
| | Open the menu of the title bar of the |
| | window currently displayed and/or |
| | selected and/or on which the metaphor |
| | is performed |
| | or |
| | Toggle to the next window |
| | or |
| | Toggle to the previous window |
| | or |
| | Highlight the menu of the window |
| | currently displayed and/or selected |
| | and/or on which the metaphor is |
| | performed whose letter is underlined |
| | or |
| | Type the character whose number is |
| | the code, (for example fist + [symbol] 128 [symbol] |
| | writes the special character [symbol] ) |
| | or |
| | Open the Start menu bar |
| | or |
| | Make the window scroll in 3D |
| | or |
| | Hide all of the elements of the desktop |
| | leaving room for the desktop wallpaper |
| | or |
| | Open the search window (Find) |
| | or |
| | Reduces all windows (Minimize all) |
| | or |
| | Open the execute window (Run) |
| | or |
| | Display the macros (Vista) or display |
| | the taskbar (if automatically hidden) |
| | or |
| | Activate the magnifier or a virtual |
| | keyboard |
| | or |
| | Open the System property window |
| | or |
| | open the Help window |
| Put a hand and/or a portion of the hand | or |
| and/or a fist and/or one or several | Rename the selected file |
| finger(s) of a hand which remains static | or |
| over the touch surface and simultaneously | Open the search window, or the search |
| draw a shape and/or a letter and/or a | panel for the explorer |
| digit and/or a special character and/or | or |
| a symbol with one or several finger(s) | Refresh an Internet page or a window |
| in the proximity of the static hand | of the Windows Explorer |
| | or |
| | Highlight the first menu of the current |
| | window |
| | or |
| | Save a document that has not already |
| | been saved (save as) |
| | or |
| | Save a document that has not already |
| | been saved (save as) |
| | or |
| | Save a portion or the entirety of the |
| | screen |
| | or |
| | Print a portion or the entirety of the |
| | screen |
| | or |
| | Copy in the clipboard a portion or the |
| | entirety of the screen |
| | or |
| | Display the context menu associated to |
| | the selected element or the object on |
| | which the metaphor is performed |
| | or |
| | Select a text when the cursor is in a |
| | word processing |
| | or |
| | Permanently delete the selected |
| | element without placing it in the recycle |
| | bin |
| | or |
| | Change the used language or switch |
| | from the Qwerty keyboard into the |
| | Azerty keyboard or vice versa |
| | or |
| | Open the Task Manager window |
| | or |
| | Quit a window (for example: Put a |
| | hand and/or a portion of the hand |
| | and/or a fist and/or one or several |
| | finger(s) of a hand which remains static |
| | over the touch surface and draw a |
| | [symbol] Q [symbol] or [symbol] q [symbol] nearby) |
| | or |
| Put a hand and/or a portion of the hand | Go to the end of the line where the |
| and/or a fist and/or one or several | cursor is located (for example: Put a |
| finger(s) of a hand which remains static | hand and/or a portion of the hand |
| over the touch surface and | and/or a fist and/or one or several |
| simultaneously draw a shape and/or a | finger(s) of a hand which remains static |
| letter and/or a digit and/or a special | over the touch surface and draw an |
| character and/or a symbol with one or | arrow [symbol] −> [symbol] or [symbol] q [symbol] nearby) |
| several finger(s) in the proximity of the | or |
| static hand | Go to the beginning of the line where |
| | the cursor is located (for example: Put |
| | a hand and/or a portion of the hand |
| | and/or a fist and/or one or several |
| | finger(s) of a hand which remains static |
| | over the touch surface and draw an |
| | arrow [symbol] <− [symbol] or [symbol] q [symbol] nearby) |
| | or |
| | Go to the line where the cursor is |
| | located (for example: Put a hand |
| | and/or a portion of the hand and/or a |
| | fist and/or one or several finger(s) of a |
| | hand which remains static over the |
| | touch surface and draw an arrow |
| | [symbol] [symbol] [symbol] nearby) |
| | or |
| | Go back one page in an Internet or |
| | Windows Explorer window |
| | or |
| | Scroll down the cursor one page |
| | or |
| | Scroll up/down the page |
| | or |
| | Open a search window of another |
| | electronic apparatus connected to the |
| | computer sharing session |
| | or |
| | Open a file navigation (Explorer) of one |
| | amongst the electronic apparatuses |
| | connected to the sharing module |
| | or |
| | Lock one or several electronic |
| | apparatus(es) (Lock) connected to the |
| | sharing module |
| | In an Internet page and/or metaphor |
| | carried out on an Internet window |
| | Select all in the page (for example: Put |
| | a hand and/or a portion of the hand |
| | and/or a fist and/or one or several |
| | finger(s) of a hand which remains static |
| | over the touch surface and draw [symbol] A [symbol] |
| | or [symbol] a [symbol] ) |
| | or |
| Put a hand and/or a portion of the hand | Copy the area, the image currently |
| and/or a fist and/or one or several | selected in the page (for example: Put |
| finger(s) of a hand which remains static | a hand and/or a portion of the hand |
| over the touch surface and | and/or a fist and/or one or several |
| simultaneously draw a shape and/or a | finger(s) of a hand which remains static |
| letter and/or a digit and/or a special | over the touch surface and draw [symbol] C [symbol] |
| character and/or a symbol with one or | or [symbol] c [symbol] ) |
| several finger(s) in the proximity of the | or |
| static hand | When the title of an address is entered, |
| | allows surfing the net without writing |
| | www and .com, Ex: Wikipedia will |
| | become www.wikipedia.org (for |
| | example: Put a hand and/or a portion |
| | of the hand and/or a fist and/or one or |
| | several finger(s) of a hand which remains |
| | static over the touch surface |
| | and draw an arrow [symbol] [symbol] [symbol] ) |
| | or |
| | Go to the address bar (for example: |
| | Put a hand and/or a portion of the hand |
| | and/or a fist and/or one or several |
| | finger(s) of a hand which remains static |
| | over the touch surface and draw [symbol] L [symbol] |
| | or [symbol] / [symbol] ) |
| | or |
| | Adjust the size of the text of the |
| | Internet page (for example: Put a hand |
| | and/or a portion of the hand and/or a |
| | fist and/or one or several finger(s) of a |
| | hand which remains static over the |
| | touch surface and simultaneously draw |
| | a point which rises and/or descends to |
| | enlarge, respectively reduce, the font |
| | size of the text currently selected |
| | and/or below the metaphor) or (Put a |
| | hand and/or a portion of the hand |
| | and/or a fist and/or one or several |
| | finger(s) of a hand which remains static |
| | over the touch surface and a relative |
| | rotation of one or several point(s) as if |
| | the second hand held a button) |
| | or |
| | Copy the text in a dialog box in the |
| | page |
| | or |
| | Scroll down the Internet page |
| | or |
| Put a hand and/or a portion of the hand | Reload the page or force the reload of |
| and/or a fist and/or one or several | the page (in the case where a server |
| finger(s) of a hand which remains static | has a cache) (for example: Put a hand |
| over the touch surface and | and/or a portion of the hand and/or a |
| simultaneously draw a shape and/or a | fist and/or one or several finger(s) of |
| letter and/or a digit and/or a special | a hand which remains static over the |
| character and/or a symbol with one or | touch surface and simultaneously draw |
| several finger(s) in the proximity of the | [symbol] F5 [symbol] or [symbol] f5 [symbol] ) |
| static hand | or |
| | Enlarge the Internet window while |
| | keeping only the navigation buttons |
| | (for example: Put a hand and/or a |
| | portion of the hand and/or a fist and/or |
| | one or several finger(s) of a hand |
| | which remains static over the touch |
| | surface and simultaneously draw [symbol] F11 [symbol] |
| | or [symbol] f11 [symbol] ) |
| | or |
| | Go to the previous page (for example: |
| | Put a hand and/or a portion of the hand |
| | and/or a fist and/or one or several |
| | finger(s) of a hand which remains static |
| | over the touch surface and draw [symbol] <− [symbol] ) |
| | or |
| | Scroll up the Internet page |
| | or |
| | Go to the page visited before going |
| | back |
| | or |
| | Open a new tab of the Internet window |
| | currently selected and/or on which the |
| | metaphor is performed (for example: |
| | Put a hand and/or a portion of the hand |
| | and/or a fist and/or one or several |
| | finger(s) of a hand which remains static |
| | over the touch surface and draw [symbol] + [symbol] |
| | or [symbol] T [symbol] and/or [symbol] t [symbol] ) |
| | or |
| | Re-open the last closed tab (for |
| | example: Put a hand and/or a portion |
| | of the hand and/or a fist and/or one or |
| | several finger(s) of a hand which |
| | remains static over the touch surface |
| | and draw [symbol] + [symbol] |
| | or [symbol] T [symbol] and/or [symbol] t [symbol] ) |
| | or |
| | Scroll down the cursor one page |
| | or |
| | Scroll up the page |
| | or |
| Put a hand and/or a portion of the hand | Insert the special character [symbol] [symbol] [symbol] , (for |
| and/or a fist and/or one or several | example: Put a hand and/or a portion |
| finger(s) of a hand which remains static | of the hand and/or a fist and/or one or |
| over the touch surface and | several finger(s) of a hand which |
| simultaneously draw a shape and/or a | remains static over the touch surface |
| letter and/or a digit and/or a special | and draw [symbol] [symbol] [symbol] ) |
| character and/or a symbol with one or | or |
| several finger(s) in the proximity of the | Insert the special character [symbol] $ [symbol] , (for |
| static hand | example: Put a hand and/or a portion |
| | of the hand and/or a fist and/or one or |
| | several finger(s) of a hand which |
| | remains static over the touch surface |
| | and draw [symbol] $ [symbol] ) |
| | or |
| | Insert the special character [symbol] & [symbol] , (for |
| | example: Put a hand and/or a portion |
| | of the hand and/or a fist and/or one or |
| | several finger(s) of a hand which |
| | remains static over the touch surface |
| | and draw [symbol] & [symbol] ) |
| | or |
| | Insert the special character [symbol] ? [symbol] , (for |
| | example: Put a hand and/or a portion |
| | of the hand and/or a fist and/or one or |
| | several finger(s) of a hand which |
| | remains static over the touch surface |
| | and draw [symbol] ? [symbol] ) |
| | or |
| | Insert the special character [symbol] @ [symbol] , (for |
| | example: Put a hand and/or a portion |
| | of the hand and/or a fist and/or one or |
| | several finger(s) of a hand which |
| | remains static over the touch surface |
| | and draw [symbol] @ [symbol] ) |
| | or |
| | Insert the special character [symbol] Ø [symbol] , (for |
| | example: Put a hand and/or a portion |
| | of the hand and/or a fist and/or one or |
| | several finger(s) of a hand which |
| | remains static over the touch surface |
| | and draw [symbol] Ø [symbol] ) |
| | or |
| Put a hand and/or a portion of the hand | Insert the special character [symbol] β [symbol] |
| and/or a fist and/or one or several | (German character = double ss), (for |
| finger(s) of a hand which remains static | example: Put a hand and/or a portion |
| over the touch surface and | of the hand and/or a fist and/or one or |
| simultaneously draw a shape and/or a | several finger(s) of a hand which |
| letter and/or a digit and/or a special | remains static over the touch surface |
| character and/or a symbol with one or | and draw [symbol] β [symbol] ) |
| several finger(s) in the proximity of the | or |
| static hand | Insert the special character [symbol] © [symbol] , (for |
| | example: Put a hand and/or a portion |
| | of the hand and/or a fist and/or one or |
| | several finger(s) of a hand which |
| | remains static over the touch surface |
| | and draw [symbol] © [symbol] ) |
| | or |
| | Insert the special character [symbol] [symbol] [symbol] , (for |
| | example: Put a hand and/or a portion |
| | of the hand and/or a fist and/or one or |
| | several finger(s) of a hand which |
| | remains static over the touch surface |
| | and draw [symbol] [symbol] [symbol] ) |
| | or |
| | Insert the special character [symbol] [symbol] [symbol] , (for |
| | example: Put a hand and/or a portion |
| | of the hand and/or a fist and/or one or |
| | several finger(s) of a hand which |
| | remains static over the touch surface |
| | and draw [symbol] [symbol] [symbol] ) |
| | or |
| | Insert the special character [symbol] ™ [symbol] , (for |
| | example: Put a hand and/or a portion |
| | of the hand and/or a fist and/or one or |
| | several finger(s) of a hand which |
| | remains static over the touch surface |
| | and draw [symbol] ™ [symbol] ) |
| | or |
| | Insert the special character [symbol] × [symbol] |
| | (multiply), (for example: Put a hand |
| | and/or a portion of the hand and/or a |
| | fist and/or one or several finger(s) of a |
| | hand which remains static over the |
| | touch surface and draw [symbol] × [symbol] ) |
| | or |
| | Insert the special character [symbol] [symbol] [symbol] , (for |
| | example: Put a hand and/or a portion |
| | of the hand and/or a fist and/or one or |
| | several finger(s) of a hand which |
| | remains static over the touch surface |
| | and draw [symbol] [symbol] [symbol] ) |
| | or |
| Put a hand and/or a portion of the hand | Insert the special character [symbol] [symbol] [symbol] , (for |
| and/or a fist and/or one or several | example: Put a hand and/or a portion |
| finger(s) of a hand which remains static | of the hand and/or a fist and/or one or |
| over the touch surface and | several finger(s) of a hand which |
| simultaneously draw a shape and/or a | remains static over the touch surface |
| letter and/or a digit and/or a special | and draw [symbol] [symbol] [symbol] ) |
| character and/or a symbol with one or | or |
| several finger(s) in the proximity of the | Insert the special character [symbol] [symbol] [symbol] , (for |
| static hand | example: Put a hand and/or a portion |
| | of the hand and/or a fist and/or one or |
| | several finger(s) of a hand which |
| | remains static over the touch surface |
| | and draw [symbol] [symbol] [symbol] ) |
| Put a hand and/or a portion of the hand | Allows increasing a value or the |
| and/or a fist and/or one or several | magnitude of a datum currently |
| finger(s) of a hand which remains static | preselected and/or below the touch |
| over the touch surface and | metaphor |
| simultaneously slip 1/2/3/4/5 fingers in | |
| the proximity of the static elements of | |
| the first hand upwards or downwards | |
| Draw a closed or partially open circular | Select the object(s) and/or the text(s) |
| shape, like a lasso, with 1/2/3/4/5 | that is/are within the lasso |
| fingers | |
| Simultaneously put 2 open or closed | Locking of the screen |
| hands and/or 10 fingers proximate to | |
| one another over the touch surface | |

In the same way

| | |
|---|---|
| Put a hand and/or a portion of the hand | Allows writing and/or inserting the |
| and/or a fist and/or one or several | shape and/or character corresponding |
| finger(s) of a hand which remains static | to that of the special characters known |
| over the touch surface and | under HTML (ISO 10646 Universal |
| simultaneously draw a shape similar | Character Set [symbol] UCS), Unicode and |
| and/or looking like and/or, complete or | TeX, such as the fine and non- |
| partial, that of the special characters | breaking spaces, the Greek, Cyrillic, |
| known under HTML (ISO 10646 | Hebrew, phonetic, Braille, Ogham, |
| Universal Character Set [symbol] UCS), | runic, Thai, Chinese alphabets, etc., |
| Unicode and TeX, such as the fine and | the mathematical symbols, the |
| non-breaking spaces, the Greek, | operators, the monetary symbols, etc. |
| Cyrillic, Hebrew, phonetic, Braille, | |
| Ogham, runic, Thai, Chinese | |
| alphabets, etc., the mathematical | |
| symbols, the operators, the monetary | |
| symbols, etc. | |

It should be noted that said metaphors could be recognized by any so-called multipoint recognition method known to those skilled in the art, such as the method described in the document U.S. Pat. No. 8,390,577 for example, or any other equivalent method, yet without departing from the scope of the invention.

Moreover, said metaphors may be combined together and/or with metaphors well known to those skilled in the art, without departing from the scope of the invention.

Finally, it is obvious that the tablets or tables with a touchscreen could consist of any electronic device well known to those skilled in the art and that the examples that have just been provided are only particular and non-limiting illustrations with regards to the fields of application of the invention.

1. A method for interaction between, on the one hand, at least one user and/or at least one first electronic device, the first electronic device comprising at least one processor or microprocessor or a graphics processor, called GPU standing for «Graphics Processing Unit», a memory, an input/output port enabling data transmission towards and from the electronic device and a display screen and, on the other hand, a second electronic device comprising at least one processor or microprocessor or a graphics processor, called GPU standing for «Graphics Processing Unit», a memory, an input/output port enabling data transmission towards and from the second electronic device and a touchscreen; wherein it includes at least the following steps:
connection of at least one user and/or a first electronic device to the second electronic, device,
generation of a first graphical user interface, called main GUI, on the touchscreen of the second electronic device for each user and/or each first electronic device connected to the second electronic device.

2. The interaction method according to claim 1, wherein it includes a step of importing into the main GUI of the user and/or of the first electronic device data and/or files and/or applications or software, or applications and software data from each user and/or from each first electronic device connected to a sharing module, the sharing module consisting of a computer program enabling the interactive sharing of data, files, applications or software, or of applications and software data on the second electronic device.

3. The interaction method according to claim 2, wherein the sharing module is recorded in a server and/or in the memory of the second electronic device and/or in the memory of the first electronic device.

4. The interaction method according to claim 1, wherein it includes a step of generating at least one second graphical user interface, called secondary GUI, related to the main GUI and in which at least one command and/or at least one datum of at least one application are displayed.

5. The interaction method according to claim 3, wherein the user connection step is carried out according to at least the following steps:
pressing for a determined duration, lasting at least 1 second, with at least one finger and/or at least the palm of the hand of a user on the touchscreen of the second electronic device,
generation of a window including a user identification system on the screen,
transmission of the login information to the sharing module,
opening of a sharing session in the sharing module after check-up of the login information of the user.

6. The interaction method according to claim 5, wherein the identification system consists of a QR code and/or a facial recognition system and/or a voice recognition system and/or a biometric recognition system and/or an identifier field and a password field.

7. The interaction method according to claim 3, wherein the user connection step is carried out according to at least the following steps:
detection of a first electronic device of a user through a wireless network or a wired network connected to the second electronic device,
transmission of the login data stored in the first electronic device from the user to the sharing module,
opening of a sharing session in the sharing module after check-up of the login data: the identifier and the password of the user.

8. The interaction method according to claim 5, wherein the login data consist of at least one identifier and one password.

9. The interaction method according to claim 1, wherein the main GUI and/or the secondary GUI(s) have a circular shape.

10. The interaction method according to claim 9, wherein the secondary GUI(s) are positioned in the proximity of the main GUI.

11. The interaction method according to claim 1, wherein it includes a step of displaying in the main GUI the profile picture of the user connected to the second electronic device or, failing that, an avatar.

12. The interaction method according to claim 11, wherein the profile picture is imported from the sharing session opened by the user and/or the first electronic device in the sharing module.

13. The interaction method according to claim 1, wherein it comprises a step of generating at least one alphanumeric pad displayed in a window associated to at least one first graphical user interface and/or to at least one second graphical user interface and/or to at least one window.

14. The interaction method according to claim 13, wherein a click on a button of the alphanumeric pad generates a code, called scan code, which is associated to a character and/or an action in the first graphical user interface and/or the second graphical user interface and/or allows writing in the window.

15. The interaction method according to claim 1, wherein it includes a step of generating at least one command from an interaction between at least one user and the second electronic device.

16. The interaction method according to claim 15, wherein a press and/or a displacement with at least one finger of at least one hand and/or of the side of at least one hand and/or of the palm of at least one hand on the touchscreen of the second electronic device generates a query transmitted to at least one amongst the electronic devices.

17. A computer program product comprising a sequence of instructions for the implementation of an interaction method according to claim 1.
